(19) United States
(12) Patent Application Publication
(10) Pub. No.: US 2009/0316418 A1
(43) Pub. Date: Dec. 24, 2009

(54) Component With a Weld Projection Having a Projection and Lamp Housing Part Comprising a Component with a Weld Projection

(75) Inventors: Bodo Mittler, Stadtbergen (DE); Thomas Schmidt-Lehmann, Hong Kong (CN)

Correspondence Address: Viering, Jentschura & Partner - OSR, 3770 Highland Ave., Suite 203, Manhattan Beach, CA, 90266, US

(73) Assignee: Patent-Treuhand Gesellschaft fur Elektrische Gluhlampen MBH, Munchen (DE)

(21) Appl. No.: 11/919,207

(22) PCT Filed: Apr. 26, 2006
(86) PCT No.: PCT/DE2006/000727

§ 371 Date: Oct. 25, 2007

(30) Foreign Application Priority Data
Apr. 27, 2005 (DE) 10 2005 019 927.5

(51) Int. Cl. F21V 15/00; B23K 26/20

(52) U.S. Cl. 362/362; 219/121.63

(57) ABSTRACT

A weld projection (8), especially for laser welding, has an indent (10) that is disposed in a first component (4) and that can be welded together with at least one second component (6). The invention is characterized in that the weld projection (8) has a projection (14) and can be brought into contact with the second component (6) via the projection. A shielding housing (1) including such a weld projection (8) for a lamp base is also disclosed.

### TECHNICAL FIELD

The invention relates to a weld projection according to the preamble of patent claim 1.

### PRIOR ART

The weld projection according to the invention may be used in principle in a large number of different welding methods. However, the main field of application of the weld projection probably comprises laser-beam welding methods, in particular for welding zinc-coated shielding housing parts of a lamp.

It is known from the general state of the art to use shielding housings of galvanized steel sheet to improve electromagnetic compatibility (EMC), for example of a discharge lamp. Such shielding housings comprise two housing parts, which enclose a plastic base of the lamp and are connected by means of a lap-welded joint. In the welding area, one of the housing parts is provided with a multiplicity of approximately half-round weld projections and by means of these can be brought into contact with the second housing part. The two housing parts are subsequently connected by means of laser-beam welding.

A disadvantage of such welded joints is that explosive evaporation of the zinc coating of the housing parts can occur during the welding, and cause holes, pores and spatter in the region of the joint. Furthermore, it is disadvantageous that the amount of heat produced during the welding leads to a reaction of the housing parts with the plastic housing and this causes the quality of the welded joint to deteriorate or makes it impossible to produce the welded joint.

### SUMMARY OF THE INVENTION

The invention is based on the object of providing a weld projection, in particular for laser-beam welding, which, by contrast with conventional solutions, prevents spatter of metal particles and makes a defined introduction of heat possible, to avoid a reaction with the plastic housing.

This object is achieved according to the invention by the features of claim 1. Particularly advantageous embodiments of the invention are described in the dependent claims.

The weld projection according to the invention has an indent, which is arranged in a first component and can be welded to at least a second component. According to the invention, the weld projection has a protrusion, by means of which it can be brought into contact with the second component for the welding. The protrusion has the effect that the components are arranged spaced apart from each other during the welding. This means that, during the welding process, the protrusion of the weld projection lies against the second component without any gap and preferably with a certain pressure, so that the distance between the components to be welded to each other is substantially determined by the height of the weld projection or its protrusion. This solution makes it possible for explosively evaporating metal particles to escape from the overlapping zone of the components. This prevents a pressure buildup between the components, and consequently prevents holes, pores and spatter. The invention can therefore be applied particularly advantageously to metal components, at least one of which has a coating of a metal that has a higher vapor pressure at the welding temperature than the metal of which the component consists. In particular, the invention can be advantageously applied to components made of galvanized steel sheet. According to the invention, the protrusion makes a defined introduction of heat into the second component possible, so that a reaction with the plastic elements arranged inside a shielding housing is avoided.

According to a particularly preferred exemplary embodiment, at least a certain portion of the protrusion has a hemispherical cross section.

The protrusion is preferably arranged centrally on an outer surface of the indent.

It has proven to be particularly advantageous if the protrusion has a height in the range from 0.03 to 0.15 mm.

The overall height of the weld projection preferably lies in the range from 0.07 to 0.40 mm.

In the case of a preferred embodiment of the invention, the heating for the welding is introduced into an inner contour of the weld projection by high-energy radiation, preferably by laser radiation.

A clearance for introducing the laser radiation is preferably formed in the inner contour of the indent.

In the case of a preferred embodiment of the invention, the components are made of galvanized steel sheet.

The weld projection according to the invention is preferably used for connecting shielding housing parts of a lamp.

### BRIEF DESCRIPTION OF THE DRAWINGS

The invention is explained in more detail below on the basis of a preferred exemplary embodiment. In the drawing:

FIG. 1 shows a schematic sectional representation through the upper part of the shielding housing depicted in FIG. 2, in the region of a weld projection.

FIG. 2 shows a plan view of a shielding housing for a lamp base.

### PREFERRED EMBODIMENT OF THE INVENTION

The invention is explained below on the basis of a weld projection for the welding of zinc-coated shielding housing parts. As already mentioned at the beginning, the weld projection according to the invention is not, however, restricted in any way to such housing parts.

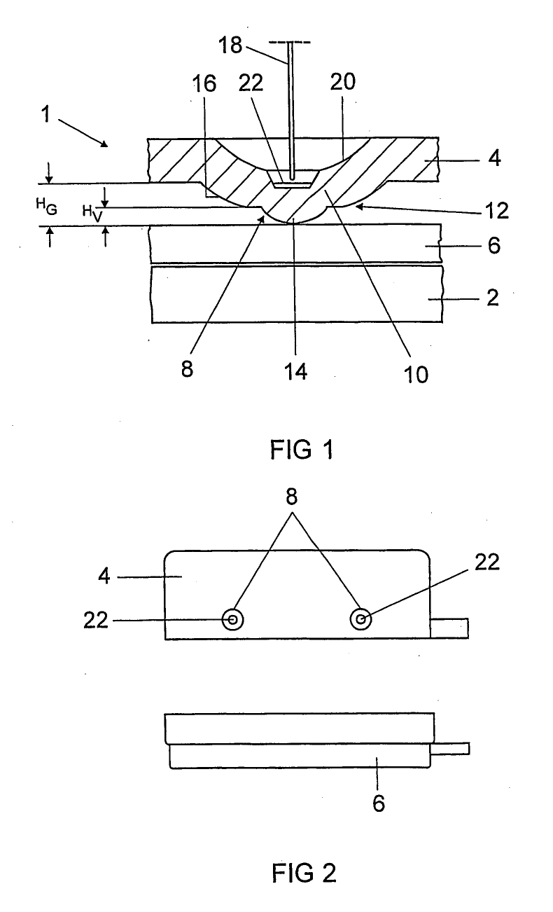

FIG. 2 shows a schematic representation of a two-part, substantially cuboidal, shielding housing, which surrounds a lamp base 2 of plastic. The upper part 4 of the shielding housing is provided on its upper side with an aperture (not represented) for the discharge vessel of the high-pressure discharge lamp. The lower part 6 overlaps with the upper part 4, so that in the overlapping region the outer wall of the lower part 6 lies against the inner wall of the upper part 4 in the area of the weld projection 8. Details of the high-pressure discharge lamp are described for example in WO 00/59269. The shielding housing 1 has two housing parts 4, 6 of galvanized steel sheet, which are provided in their overlapping zone, represented in FIG. 1, with a multiplicity of weld projections 8. For reasons of overall clarity, only one of the weld projections 8 is represented in FIG. 1. This projection has an indent 10, which is formed in the first housing part 4. According to the invention, an approximately hemispherical protrusion 14 is formed on an end portion 12 of the weld projection 8 that is facing the second housing part 6. This protrusion is brought into contact with the second housing part 6 for the welding, the housing parts 4, 6 being arranged spaced apart from each other by the protrusion 14. According to the invention, zinc that evaporates during the welding can escape from the overlapping zone, so that pressure is prevented from developing. As a result, holes, pores and spatter are avoided and there is no need for any finishing of the component surface after the welding operation. Furthermore, a defined, i.e. locally delimited, introduction of heat into the second housing part 6 is made possible by the protrusion 14 of the weld projection 8, so that excessive heating of the second housing part 6 is avoided, and therefore so is a reaction with the plastic base 2 arranged under it. As a result, higher welding quality is achieved and the corrosion resistance in the welding area is improved. According to FIG. 1, the protrusion 14 is arranged approximately centrally on an outer surface 16 of the indent 10 and has a height H_{V} of 0.09 mm, with an overall height H_{G} of the weld projection 8 of 0.24 mm. The weld projection 8 can be introduced into the component 4 in a simple way by conventional embossing tools and, as a result, can be produced at low cost. In the case of the exemplary embodiment shown, the heating to welding temperature is performed by a laser beam 18, which is introduced in the region of an inner contour 20 of the weld projection 8. The defined introduction of heat into the welding location is further improved by an approximately frustoconical clearance 22 in the inner contour 20 of the indent 10.

The weld projection 8 according to the invention is not restricted to the described joining technique by means of laser-beam welding, but rather any welding method known from the prior art that makes a defined introduction of heat into the welding area possible can be used. Furthermore, the method according to the invention can also be applied to components of different metals and is not restricted to galvanized steel sheets.

A weld projection 8, in particular for laser-beam welding, with an indent 10, which is arranged in a first component 4 and can be welded to at least a second component 6, is disclosed. According to the invention, the weld projection 8 has a protrusion 14 and by means of this can be brought into contact with the second housing part 6 for the welding.

1. A weld projection, in particular for laser-beam welding, with an indent (10), which is arranged in a first component (4) and can be welded to at least a second component (6), characterized in that the weld projection (8) has a protrusion (14) and by means of this can be brought into contact with the second component (6) for the welding.

2. The weld projection as claimed in claim 1, at least a certain portion of the protrusion (14) having a hemispherical cross section.

3. The weld projection as claimed in claim 1, the protrusion (14) being arranged centrally on an outer surface (16) of the indent (10).

4. The weld projection as claimed in claim 1, the protrusion (14) having a height (H_{V}) in the range from 0.03 to 0.15 mm.

5. The weld projection as claimed in claim 1, the overall height (H_{G}) of the weld projection (8) lying in the range from approximately 0.07 to 0.40 mm.

6. The weld projection as claimed in claim 1, the heating for the welding being introduced into an inner contour (20) of the weld projection (8) by high-energy radiation, preferably by laser radiation.

7. The weld projection as claimed in claim 6, the inner contour (20) of the indent (10) having a clearance (22) for introducing the laser radiation.

8. The weld projection as claimed in claim 1, the components (4, 6) being made of galvanized steel sheet.

9. The weld projection as claimed in claim 1, the weld projection (8) being used for connecting shielding housing parts (4, 6) of a lamp.

10. A lamp housing part (4, 6) made of metal with at least one weld projection as claimed in claim 1.

11. The lamp housing part (4, 6) as claimed in claim 10, the metal being galvanized steel sheet.

12. The lamp housing part (4, 6) as claimed in claim 10, the lamp housing part (4, 6) consisting of a first metal and being provided with a coating of a second metal, which has a higher vapor pressure at the welding temperature than the first metal.

13. The weld projection as claimed in claim 2, the protrusion (14) being arranged centrally on an outer surface (16) of the indent (10).
